(19) United States
(12) Patent Application Publication
(10) Pub. No.: US 2024/0367139 A1
(43) Pub. Date: Nov. 7, 2024

(54) RAPID MATERIAL SYNTHESIS REACTOR SYSTEMS, METHODS, AND DEVICES

(71) Applicant: 6K Inc., North Andover, MA (US)

(72) Inventors: Gregory M. Wrobel, West Newbury, MA (US); Adrian Pullen, Boston, MA (US); Richard K. Holman, Wellesley, MA (US); Darrin Liau, Tewksbury, MA (US); Kim Tran, Shrewsbury, MA (US)

(21) Appl. No.: 18/653,434

(22) Filed: May 2, 2024

Related U.S. Application Data
(60) Provisional application No. 63/500,187, filed on May 4, 2023.

(51) Int. Cl. B01J 19/20; C01G 49/00

(52) U.S. Cl. CPC B01J 19/20; C01G 49/009; B01J 2219/00141; B01J 2219/00772; B01J 2219/0879; B01J 2219/0898

(57) ABSTRACT

Disclosed herein are systems, methods, and devices for rapid synthesis of materials. In some embodiments, a system may comprise a material processing apparatus for processing a material, the material processing apparatus comprising a material passage structure in communication with a material feeding inlet, the material passage structure located within a reaction chamber, and the material feeding inlet configured to receive a material and transfer the material to the material passage structure; and a heat source in communication with the reaction chamber, the heat source comprising one or more of: plasma, flame, combustion sources, resistive heaters, heated liquid baths, electromagnetic radiation, and/or induction heaters, wherein the material passage structure is located within, surrounding, or adjacent to the heat source, such that the material passage structure is heated by the heat source and the material is converted to a product within the material passage structure.

### INCORPORATION BY REFERENCE TO ANY PRIORITY APPLICATIONS

The present application claims the benefit under 35 U.S.C. 119(c) to U.S. Provisional Patent Application No. 63/500,187 filed May 4, 2023, titled “RAPID MATERIAL SYNTHESIS REACTOR SYSTEMS, METHODS, AND DEVICES,” the entirety of which is hereby incorporated herein by reference under 37 CFR 1.57. Any and all applications for which a foreign or domestic priority claim is identified in the Application Data Sheet as filed with the present application are hereby incorporated by reference under 37 CFR 1.57.

### BACKGROUND

### Field

The present invention relates to apparatuses and methods for material processing and, more particularly, to apparatuses and methods for rapid material synthesis.

### Description

The manufacture of desirable materials may involve various processes. For example, powder synthesis involves the creation of a powder from raw materials through chemical reactions or physical processes such as precipitation, sol-gel processing, or spray drying. Other processes, such as powder blending, compaction, sintering, coating, and/or metallurgy are commonly used for processing powders to manufacture a desired material.

Current material processing methods have various disadvantages that necessitate novel material synthesis processes. Current processes require high amounts of energy, which can contribute to higher production costs and environmental impacts. Furthermore, some processes may produce powders having inconsistent quality due to the difficulty in controlling the process parameters. For instance, it can be difficult to achieve a narrow particle size distribution with some powder processing methods, which can affect the performance of the final product. Also, some powder processing methods are limited to certain types of materials, which can restrict the range of products that can be manufactured. Additionally, certain powder processing methods require specialized equipment and skilled operators, which can make them difficult and expensive to set up and maintain safely.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to a microwave plasma apparatus for processing a material, comprising: a material passage structure in communication with a material feeding inlet, the material passage structure located within a reaction chamber, and the material feeding inlet configured to receive a material and transfer the material to the material passage structure; a microwave plasma generator in communication with the reaction chamber, the microwave plasma generator configured to generate microwave power; and a waveguide configured to transmit the microwave power to the reaction chamber to produce a microwave plasma; wherein the material passage structure is located within, surrounding, or adjacent to the produced microwave plasma, such that the material passage structure is heated by the microwave plasma and the material is converted to a product within the material passage structure.

In some embodiments, the material passage structure comprises a helix geometry. In some embodiments, the microwave plasma apparatus comprises a plurality of material passage structures, each material passage structure in communication with a material feeding inlet. In some embodiments, each material passage structure comprises a helix. In some embodiments, at least one material passage structure is nested within another material passage structure. In some embodiments, at least one material passage structure is intertwined with another material passage structure. In some embodiments, the plurality of material passage structures comprises 2, 3, 4, 5, 6, 7, 8, 9, or 10 material passage structures.

In some embodiments, the product comprises lithium iron phosphate (LFP). In some embodiments, the product comprises a ceramic material.

In some embodiments, the material passage structure comprises an enclosed tube, pipe, a trough, unenclosed pipe, unenclosed tube, helical gas flow path, parallel cylinders, parallel cones, offset cylinders, and/or offset cones.

Some embodiments herein are directed to a material processing apparatus for processing a material, the material processing apparatus comprising: a material passage structure in communication with a material feeding inlet, the material passage structure located within a reaction chamber, and the material feeding inlet configured to receive a material and transfer the material to the material passage structure; and a heat source in communication with the reaction chamber, the heat source comprising one or more of: plasma, flame, combustion sources, resistive heaters, heated liquid baths, electromagnetic radiation, and/or induction heaters; wherein the material passage structure is located within, surrounding, or adjacent to the heat source, such that the material passage structure is heated by the heat source and the material is converted to lithium iron phosphate (LFP) within the material passage structure.

In some embodiments, the heat source comprises a microwave plasma.

In some embodiments, the material passage structure comprises a helix geometry. In some embodiments, the microwave plasma apparatus comprises a plurality of material passage structures, each material passage structure in communication with a material feeding inlet. In some embodiments, each material passage structure comprises a helix. In some embodiments, at least one material passage structure is nested within another material passage structure. In some embodiments, at least one material passage structure is intertwined with another material passage structure. In some embodiments, the plurality of material passage structures comprises 2, 3, 4, 5, 6, 7, 8, 9, or 10 material passage structures.

Some embodiments herein are directed to a method for producing lithium iron phosphate (LFP), the method comprising: inputting a material to a material feeding inlet, the material feeding inlet in communication with a material passage structure, the material passage structure located within a reaction chamber; transferring the material to the material passage structure; and heating the material within the material passage structure by a heat source in communication with the reaction chamber, the heat source comprising one or more of: plasma, flame, combustion sources, resistive heaters, heated liquid baths, electromagnetic radiation, and/or induction heaters, wherein the material passage structure is located within, surrounding, or adjacent to the heat source, such that the material passage structure is heated by the heat source and the material is converted to lithium iron phosphate (LFP) within the material passage structure.

In some embodiments, the heat source comprises a microwave plasma. In some embodiments, the material passage structure comprises a helix geometry. In some embodiments, the microwave plasma apparatus comprises a plurality of material passage structures, each material passage structure in communication with a material feeding inlet. In some embodiments, each material passage structure comprises a helix. In some embodiments, at least one material passage structure is nested within another material passage structure. In some embodiments, at least one material passage structure is intertwined with another material passage structure. In some embodiments, the plurality of material passage structures comprises 2, 3, 4, 5, 6, 7, 8, 9, or 10 material passage structures.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an example microwave plasma torch 100 that can be used in the processing of feed material materials.

FIGS. 2A-B illustrates an exemplary microwave plasma torch that includes a side feeding hopper, thus allowing for downstream feeding.

FIG. 3 illustrates an exemplary apparatus for material rapid synthesis according to some embodiments herein.

FIG. 4 illustrates an exemplary material passage structure for use in a rapid synthesis system according to some embodiments herein.

FIG. 5 illustrates another exemplary material passage structure for use in a rapid synthesis system according to some embodiments herein.

FIG. 6 illustrates another exemplary material passage structure for use in a rapid synthesis system according to some embodiments herein.

FIG. 7 illustrates another exemplary material passage structure for use in a rapid synthesis system according to some embodiments herein.

FIG. 8 illustrates another exemplary material passage structure for use in a rapid synthesis system according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto or as presented in the future is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

The embodiments herein are generally directed to material rapid synthesis systems, methods, and devices. Some embodiments herein are directed to rapidly heating powders to a synthesis temperature and providing sufficient residence time to continuously synthesize materials, such as lithium iron phosphate (LFP), without crucibles/saggars. LFP is a cost-effective cathode material for lithium-ion cells that is known to deliver excellent safety and excellent lifespan, which makes LFP particularly well-suited for specialty battery applications requiring high load currents and endurance. LFP is a cathode material commonly used in lithium-ion batteries, and its properties can be characterized using various techniques such as X-ray diffraction (XRD), scanning electron microscopy (SEM), transmission electron microscopy (TEM), and electrochemical testing. To process LFP for use in a battery, the material typically undergoes steps such as milling, synthesis, and annealing.

In some embodiments, material may be synthesized in a time range between less than a second and several minutes. For example, in some embodiments, material may be synthesized in about 0.1 s, about 0.2 s, about 0.3 s, about 0.4 s, about 0.5 s, about 0.6 s, about 0.7 s, about 0.8 s, about 0.9 s, about 1 s, about 2 s, about 3 s, about 4 s, about 5 s, about 6 s, about 7 s, about 8 s, about 9 s, about 10 s, about 15 s, about 20 s, about 25 s, about 30 s, about 35 s, about 40 s, about 45 s, about 50 s, about 55 s, about 1 min, about 2 min, about 3 min, about 4 min, about 5 min, about 6 min, about 7 min, about 8 min, about 9 min, about 10 min, about 11 min, about 12 min, about 13 min, about 14 min, about 15 min, about 16 min, about 17 min, about 18 min, about 19 min, about 20 min, about 21 min, about 22 min, about 23 min, about 24 min, about 25 min, about 26 min, about 27 min, about 28 min, about 29 min, about 30 min, about 31 min, about 32 min, about 33 min, about 34 min, about 35 min, about 36 min, about 37 min, about 38 min, about 39 min, about 40 min, about 41 min, about 42 min, about 43 min, about 44 min, about 45 min, about 46 min, about 47 min, about 48 min, about 49 min, about 50 min, about 51 min, about 52 min, about 53 min, about 54 min, about 55 min, about 56 min, about 57 min, about 58 min, about 59 min, about 60 min, and/or any value between the aforementioned values.

In some embodiments, the rapid synthesis systems, methods, and devices described herein may comprise a heat source, such as, for example, a microwave plasma heat source. In some embodiments, the heat source may comprise a non-microwave plasma heat source, such as a radio frequency (RF), induction, or ARC plasma, among others. In other embodiments, a flame or combustion heat source may be used. In some embodiments, the heat source may comprise one or more of: plasma, flame and combustion sources, resistive heaters, heated liquid baths, electromagnetic radiation, and/or induction heaters.

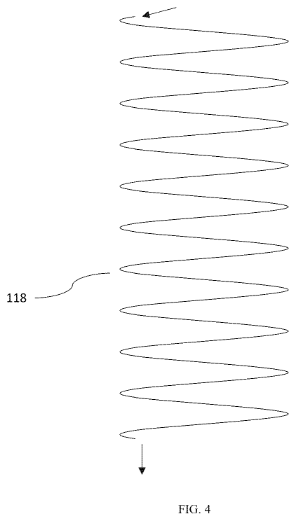

In some embodiments, the rapid synthesis systems, methods, and devices described herein may comprise hardware, such as a material passage structure comprising a precursor input and a passage body. In some embodiments, the material passage structure is heated by the heat source. In some embodiments, a precursor, such as a solid powder material may be input to the precursor input of the material passage structure and flowed through the heated passage body. In some embodiments, the precursor may be processed in a microwave plasma apparatus without the use of a material passage structure. In some embodiments, the precursor may comprise lithium carbonate, iron phosphate, iron oxide, iron citrate, iron acetate, phosphoric acid, and/or polyvinyl alcohol. In some embodiments, flowing the precursor through the heated passage body may convert the precursor into a product, such as a high-tech ceramic material. In some embodiments, the material passage structure may comprise an enclosed tube or pipe, a trough (i.e., unenclosed pipe/tube), a helical gas flow path, and/or parallel or offset cylinders or cones, among others. In some embodiments, traditional heat exchanger geometries may be utilized in a material passage structure, such as a shell and tube, plate, spiral, finned tube, double pipe (i.e. concentric pipes), coiled tube, plate-fin, scraped surface, and/or cross flow geometry. In some embodiments, the material passage structure may be oriented in any direction relative to the flow of the gas flow including, for example, in an orientation parallel, perpendicular, or at any angle relative to the gas flow. Some example material passage structure geometries are shown in FIGS. 4-8. In some embodiments, the material passage structure may be enclosed within a reactor. In some embodiments, the material rapid synthesis systems, methods, and devices described herein may comprise a product output and collection at a terminal end of the material passage structure. In some embodiments, the rapid synthesis systems, methods, and devices described herein may facilitate control of process gases, such as CO₂ and H₂O in a microenvironment within the reactor, wherein the material passage structure enables rapid heat up and cool down while controlling the gasses.

In some embodiments, the rapid synthesis systems, methods, and devices described herein use specific hardware geometry to synthesize material within seconds to minutes by passing material through a well-defined and adaptable thermal history including a process gas. In some embodiments, the process hardware can be heated with plasma, resistive heaters, combustion sources or other heat sources, as discussed above. In some embodiments, the material passage structure may comprise nested, intertwined, and/or parallel geometric structures such as helixes. In some embodiments, the rapid synthesis systems, methods, and devices described herein may comprise 1, 2, 3, 4, 5, 6, 7, 8, 9, 10, 11, 12, 13, 14, 15, 16, 17, 18, 19, 20, 25, 30, 35, 40, 45, 50, 75, or 100 material passage structures, or any number between the aforementioned numbers.

In some embodiments, the rapid synthesis systems, methods, and devices described herein provide rapid continuous synthesis of materials with consistent thermal history a uniform particle-to-particle properties/performance. In contrast, conventional furnace technology slowly ramps material up to temperature to prevent thermal shock of the resistive heaters and crucibles/saggars. In conventional technologies, ramp times typically are in the range of several hours. Furthermore, particle thermal history varies because the material at the top of a crucible rapidly heats while it may take hours for material in the center of a crucible/saggar to heat to the desired temperature because of the slow nature of heat conduction through a powder bed.

Unlike spray drier, flash calcination, or spray pyrolysis systems in which decomposition gasses are rapidly swept away from the material surface, the hardware of the rapid synthesis systems, methods, and devices described herein, if desired, allows material to soak in the decomposition gasses, which may benefit rapid material synthesis. Alternatively, if beneficial, decomposition gasses can be swept away from the material. In some embodiments, process gas can be chosen as chemically oxidative, neutral, or reducing. In some embodiments, process gases may comprise nitrogen, argon, oxygen, hydrogen, helium, a noble gas, and/or a combination of one or more of the above gases. In some embodiments, material is carried through the material passage structure by one or more gas flows. For example, material may be entrained within the feed gas flow or pushed along to the terminal end of the material passage structure by the feed gas flow.

Furthermore, unlike other reaction furnaces, such as pulse furnaces, the rapid synthesis systems, methods, and devices described herein are not limited to systems that use natural gas combustion as a heat source, which expose material to the combustion emissions of water vapor, CO₂, and/or CO. In some embodiments, the hardware, such as, for example, the material passage structure utilized within the rapid synthesis systems, methods, and devices described herein allow for ultrapure gases to be utilized. For example, process gases may comprise oxidative, neutral, or reducing gases. In some embodiments, the material passage structure may also function to increase residence time of the precursor within a reaction chamber. For example, if the precursor is flowed through a material passage structure having a helical design, the residence time of the precursor will be increased relative to processing material by inputting the material directly into the reaction chamber with no material passage structure. In addition, in some embodiments, the material passage structure may provide a defined path for the precursor material to follow through the reaction chamber and temperature profile therein, providing a consistent thermal history for all precursor flowed through the material passage structure, as long as the temperature profile is maintained over time. Thus, in some embodiments, the rapid synthesis systems, methods, and devices described herein may rapidly heat precursor powders to a synthesis temperature and provide sufficient residence time to continuously synthesize materials, such as lithium iron phosphate (LFP).

In some embodiments, the rapid synthesis systems, methods, and devices described herein may be used to process ceramic materials. Ceramics are an important class of materials with widespread applications because of their high thermal, mechanical, and chemical stability. The most important uses of advanced ceramics in volume and value are generally in electronics. While alumina is by far the largest item for use as substrates, insulators, etc., specialized ceramics (e.g., ferro-electric, piezoelectric, semiconducting, and magnetic) are also useful in a variety of application. Ceramics may be used excellent electric insulators, but it is now possible to confer high electrical conductivity in ceramics.

Synthesizing ceramics can require heating for long times at high temperatures, making the screening of high-through-put materials challenging. Conventional ceramic processes include pressing, slip casting, extrusion, drying, and firing, among others. For example, high-tech ceramics are conventionally batch synthesized in furnaces using crucibles/saggars for periods between 3 hours to 12 hours. The demand for advanced high-tech ceramics with specific applications necessitates the improvement and the optimization of processing techniques as well as the development of new techniques.

In some embodiments, the rapid synthesis systems, methods, and devices described herein may be used to process carbon nanotube (CNT) materials. In some embodiments, the CNT materials may comprise cylindrical nanostructures made of carbon atoms arranged in a hexagonal pattern. In some embodiments, the CNT materials comprise single-walled or multi-walled CNT materials. In some embodiments, single-walled CNTs comprise a diameter of about one nanometer and a length of several micrometers. CNTs exhibit exceptional mechanical, electrical, and thermal properties, making them attractive for a variety of applications. In some embodiments, CNT materials may be produced by using CO₂ or other carbon-containing gas as process gas in the rapid synthesis systems, methods, and devices described herein.

In some embodiments, production of CNTs using the rapid synthesis systems, methods, and devices described herein may improve on existing methods for producing CNTs. For example, an existing approach to producing CNTs is through chemical vapor deposition (CVD). In this process, CO₂ is mixed with a reducing agent such as hydrogen, and the mixture is heated to a high temperature in the presence of a catalyst. The carbon atoms in the CO₂ are then reduced and deposited onto the catalyst surface, forming CNTs. Another approach is to use electrochemical methods to convert CO₂ into carbon precursors, which can then be used to synthesize CNTs. This process involves passing a current through a CO₂-containing electrolyte to produce carbon precursors, which are then used in a CVD process to produce CNTs.

The ability to produce CNTs from CO₂ has potential environmental and economic benefits as it provides a way to utilize CO₂ emissions from industrial processes to create valuable materials. However, existing CO₂ conversion processes can be expensive due to the high cost of equipment, catalysts, and other materials required. In some embodiments, CNT materials can be generated using the rapid synthesis systems, methods, and devices described herein without the use of a catalyst.

Also, the efficiency of existing CO₂ conversion processes is often low, meaning that only a small fraction of the CO₂ is converted into CNTs. This inefficiency can make the process economically unviable. In some embodiments, CO₂ conversion may be substantially higher than existing processes using the rapid synthesis systems, methods, and devices described herein. Additionally, the rapid synthesis systems, methods, and devices described herein may improve on the purity of CNTs produced using existing processes, have better scalability through a continuous manufacturing process, and lessen the environmental impact and energy consumption relative to existing processes.

In some embodiments, the rapid synthesis systems, methods, and devices described herein may be used to process graphene, carbon nanofibers, fullerenes, carbon nanohorns, carbon nanodots, or other carbon materials.

### Plasma Heat Sources

In some embodiments, the rapid synthesis systems, methods, and devices described herein may utilize a plasma heat source. Plasma torches generate and provide high temperature directed flows of plasma for a variety of purposes. The two main types of plasma torches are induction plasma torches and microwave plasma torches. Generally, inductive plasmas suffer from plasma non-uniformity. This non-uniformity leads to limitations on the ability of inductive plasmas to process certain materials. Furthermore, significant differences exist between the microwave plasma apparatuses and other plasma generation torches, such as induction plasma. For example, microwave plasma is hotter on the interior of the plasma plume, while induction is hotter on the outside of the plumes. In particular, the outer region of an induction plasma can reach about 10,000 K while the inside processing region may only reach about 1,000 K. This large temperature difference leads to material processing and feeding problems. Furthermore, induction plasma apparatuses are unable to process feedstocks at low enough temperatures to avoid melting of certain feed materials without extinguishing the plasma.

A conventional microwave plasma apparatus for processing a material includes a plasma chamber, an applicator, a microwave radiation source, and a waveguide guiding microwave radiation from the microwave radiation source to the plasma chamber. A process gas flows through the plasma chamber and the microwave radiation couples to the process gas to produce a plasma jet. A process material is introduced to the plasma chamber, becomes entrained in the plasma jet, and is thereby transformed to a stream of product material droplets or particles. In some embodiments, the process gas may be used not only to generate a plasma, but also as a reactant in a chemical reaction with the material. In some embodiments herein, the process material may be introduced into a material passage structure. In some embodiments, the material passage structure surrounds the plasma. In some embodiments, the diameter of the material passage structure relative to the diameter of the plasma plume may be important to achieve the desired temperature profile. In some embodiments, the material passage structure geometry and sizing may be turned to achieve the desired temperature profile.

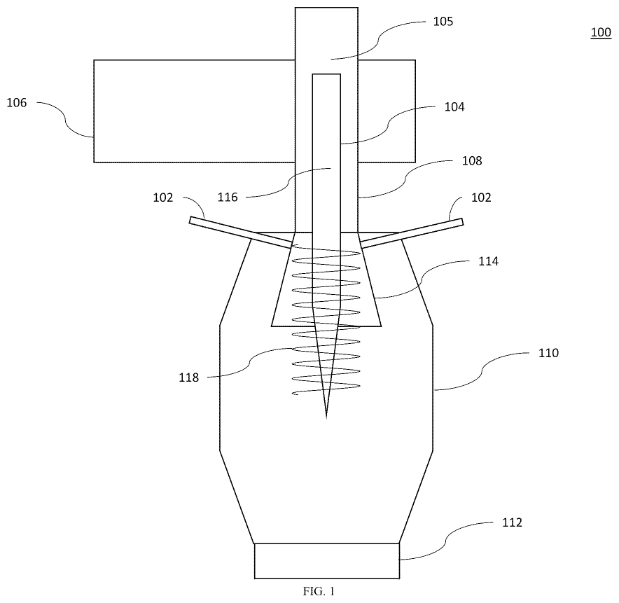

FIG. 1 illustrates an example microwave plasma torch 100 that can be used in the production of materials. In some embodiments, a feedstock (e.g., material precursor) can be introduced, via one or more feedstock inlets 102, directly into a microwave plasma 104 or into a material passage structure 118 that is located adjacent, within, and/or surrounding the microwave plasma 104. In some embodiments, an entrainment gas flow and/or a sheath flow may be injected into the microwave plasma applicator 105 to create flow conditions within the plasma applicator prior to ignition of the plasma 104 via microwave radiation source 106. In some embodiments, the entrainment flow and sheath flow are both axis-symmetric and laminar, while in other embodiments the gas flows are swirling or turbulent. In some embodiments, the feedstock may be introduced into the microwave plasma torch 100, where the feedstock may be entrained by a gas flow that directs the materials toward the plasma 104. In some embodiments, the feedstock may travel through the one or more feedstock inlets 102 to a material passage structure 118. In some embodiments, the one or more feedstock inlets 102 may be in communication with a plurality of material passage structures. In some embodiments, the microwave plasma torch may comprise 1, 2, 3, 4, 5, 6, 7, 8, 9, 10, 11, 12, 13, 14, 15, 16, 17, 18, 19, 20, 25, 30, 35, 40, 45, 50, 75, or 100 material passage structures, or any number between the aforementioned numbers.

In some embodiments, within the microwave plasma 104, the feedstock may undergo a physical and/or chemical transformation. Inlets 102 can be used to introduce process gases to entrain and accelerate the feedstock towards plasma 104. In some embodiments, a second swirling gas flow can be created to provide sheathing for the inside wall of a plasma applicator 104 and a reaction chamber 110 to protect those structures from melting due to heat radiation from plasma 104.

Various parameters of the microwave plasma 104, as created by the plasma applicator 105, may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into a sealed chamber 112 where the material is quenched then collected.

In some embodiments, the feedstock is injected after the microwave plasma applicator for processing in the “plume” or “exhaust” of the microwave plasma torch. Thus, the plasma of the microwave plasma torch is engaged at the exit end of the plasma torch core tube 108, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 102. Furthermore, the feedstock may enter the plasma at a specific position along the length of the plasma 104 by adjusting placement of the inlets 102, where a specific temperature has been measured and a residence time estimated for providing the desirable characteristics of the resulting material.

In some embodiments, the angle of the inlets 102 relative to the plasma 104 may be adjusted, such that the feedstock can be injected at any angle relative to the plasma 104. In some embodiments, implementation of the downstream injection method may use a downstream swirl or quenching. A downstream swirl refers to an additional swirl component that can be introduced downstream from the plasma applicator to keep the powder from the walls of the applicator 105, the reactor chamber 110, and/or an extension tube 114.

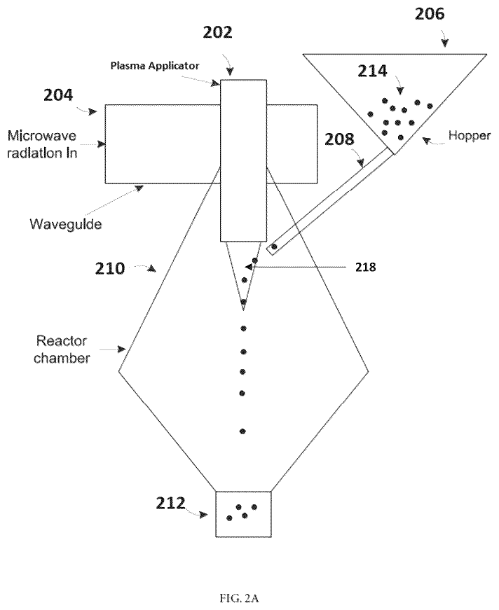

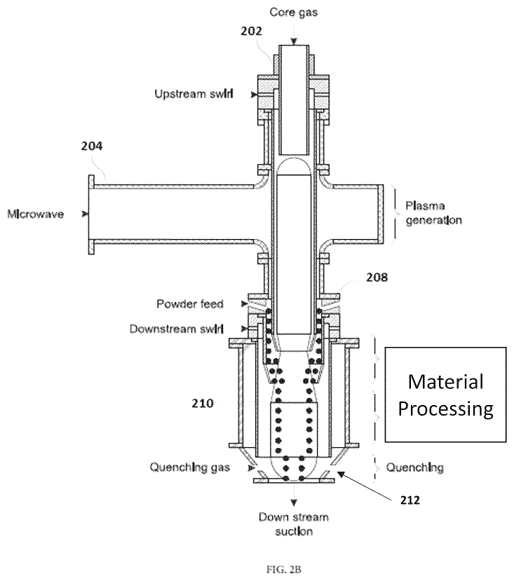

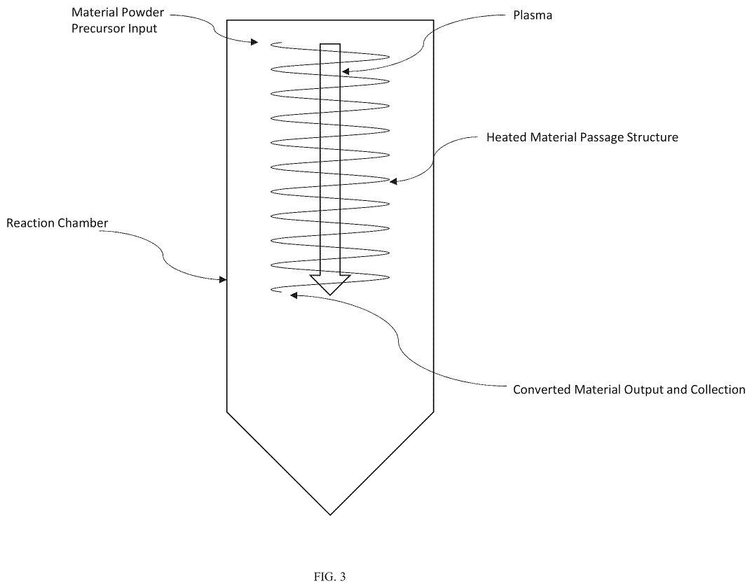

FIGS. 2A-B illustrates an exemplary microwave plasma torch that includes a side feeding hopper, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding). This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream feeding can utilize two main hardware configurations to establish a stable plasma plume which are: annular torch, such as described in U.S. Pat. Pub. No. 2018/0297122, the entirety of which is hereby incorporated by reference, or swirl torches described in U.S. Pat. No. 8,748,785 B2 and U.S. Pat. No. 9,932,673 B2, the entireties of which are hereby incorporated by reference. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 214 can be introduced into a microwave plasma applicator 202. A hopper 206 can be used to store the feed material 214 before feeding the feed material 214 into the microwave plasma applicator 202, plume and/or exhaust 218. The feed material 214 can be injected at any angle to the longitudinal direction of the plasma applicator 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma applicator 202 through a waveguide 204. The feed material 214 is fed into a plasma chamber 210 and is placed into contact with the plasma generated by the plasma applicator 202. When in contact with the plasma, plasma plume, or plasma exhaust 218, the feed material melts. While still in the plasma chamber 210, the feed material 214 cools and solidifies before being collected into a container 212. In some embodiments, solid state chemical reactions occur and, thus, solidification is not required. Alternatively, the feed material 214 can exit the plasma chamber 210 through the outlet 212 while still in a melted phase and cool and solidify outside the plasma chamber. In some embodiments, a quenching chamber may be used, which may or may not use positive pressure. While described separately from FIG. 1, the embodiments of FIGS. 2A and 2B are understood to use similar features and conditions to the embodiment of FIG. 1.

### Material Passage Structure

In some embodiments, the rapid synthesis systems, methods, and devices described herein may comprise one or more material passage structures for directing and processing a feedstock comprising a material precursor within a reactor/reaction chamber. In some embodiments, the one or more material passage structures provide a well-defined and adaptable thermal history for processing of the precursor particles. In some embodiments, the one or more material passage structures may provide uniform particle-to-particle properties and/or performance. In some embodiments, the one or more material passage structures may be heated via one or more heat sources.

FIG. 4 illustrates an exemplary material passage structure for use in a rapid synthesis system according to some embodiments herein. In some embodiments, the material passage structures described herein may be formed of stainless steel, such as, for example, 304 stainless steel or 316 stainless still. In some embodiments, the material passage structures described herein may be formed of nickel, nickel alloys, quartz, and/or alumina. In some embodiments, the one or more material passage structures 118 may comprise a helix geometry, spiraling downward through a reactor/reaction chamber and through, surrounding, and/or adjacent to a plasma or other heat source. In some embodiments, the precursor may be processed within the one or more material passage structures 118 to convert the precursor to a product. The product may be output from the one or more material passage structures 118 into one or more material collection structures such as into a sealed chamber 112 where the product may be quenched then collected. In some embodiments, the helix geometry may comprise a spiral or coiled arrangement of a material, such as quartz tube. In some embodiments, arrangement may surround a central axis, forming a spiral shape. In some embodiments, the angle and pitch of the spiral, as well as the diameter and composition of the arrangement may vary depending on specific processing needs.

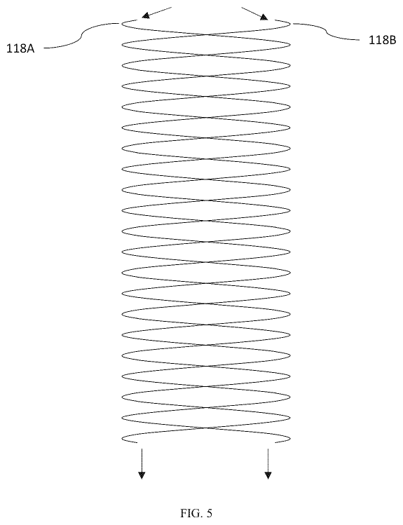

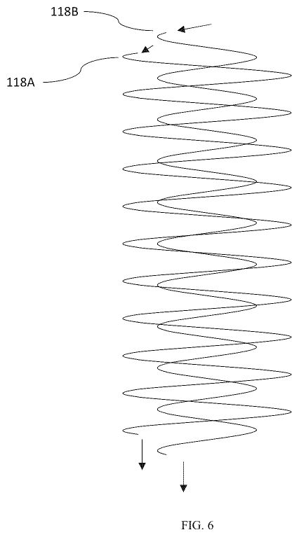

FIGS. 5 and 6 illustrate other exemplary material passage structures for use in a rapid synthesis system according to some embodiments herein. In some embodiments, the rapid synthesis system may comprise more than on material passage structures, such as intertwined, nested, and/or overlapping helix geometries. In some embodiments, each material passage structure may provide identical processing parameters and identical products. In other embodiments, each material structure may provide a different thermal profile, which may be tailored to provide a product having particles with different properties. In some embodiments, each material passage structure may be connected to a different material inlet 102. In some embodiments, each material passage structure may be connected to the same material inlet 102. In some embodiments, a first material passage structure 118A may be intertwined with a second material passage structure 118B, as shown in FIG. 5. In some embodiments, a first material passage structure 118A may be nested within a second material passage structure 118B, as shown in FIG. 6.

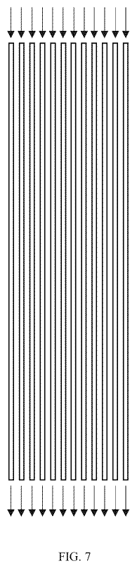

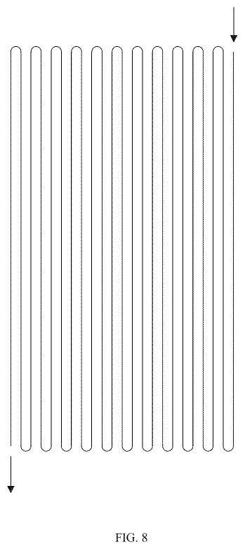

FIGS. 7 and 8 illustrate other exemplary material passage structures for use in a rapid synthesis system according to some embodiments herein. As discussed above, in some embodiments such as that illustrated in FIG. 8, typical radiator geometries may be used, such as wherein the material passage structure comprises a series of vertically, horizontally, or angled mounted tubes continuously connected with 180 degree elbows. In other embodiments, such as that illustrated in FIG. 7, vertical, horizontal, or angled straight tubes may be utilized.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, 15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A microwave plasma apparatus for processing a material, comprising:
a material passage structure in communication with a material feeding inlet, the material passage structure located within a reaction chamber, and the material feeding inlet configured to receive a material and transfer the material to the material passage structure;
a microwave plasma generator in communication with the reaction chamber, the microwave plasma generator configured to generate microwave power; and
a waveguide configured to transmit the microwave power to the reaction chamber to produce a microwave plasma;
wherein the material passage structure is located within, surrounding, or adjacent to the produced microwave plasma, such that the material passage structure is heated by the microwave plasma and the material is converted to a product within the material passage structure.

2. The microwave plasma apparatus of claim 1, wherein the material passage structure comprises a helix geometry.

3. The microwave plasma apparatus of claim 1, wherein the microwave plasma apparatus comprises a plurality of material passage structures, each material passage structure in communication with a material feeding inlet.

4. The microwave plasma apparatus of claim 3, wherein each material passage structure comprises a helix.

5. The microwave plasma apparatus of claim 4, wherein at least one material passage structure is nested within another material passage structure.

6. The microwave plasma apparatus of claim 4, wherein at least one material passage structure is intertwined with another material passage structure.

7. The microwave plasma apparatus of claim 3, wherein the plurality of material passage structures comprises 2, 3, 4, 5, 6, 7, 8, 9, or 10 material passage structures.

8. The microwave plasma apparatus of claim 1, wherein the product comprises lithium iron phosphate (LFP).

9. The microwave plasma apparatus of claim 1, wherein the product comprises a ceramic material.

10. The microwave plasma apparatus of claim 1, wherein the material passage structure comprises an enclosed tube, pipe, a trough, unenclosed pipe, unenclosed tube, helical gas flow path, parallel cylinders, parallel cones, offset cylinders, and/or offset cones.

11. A material processing apparatus for processing a material, the material processing apparatus comprising:
a material passage structure in communication with a material feeding inlet, the material passage structure located within a reaction chamber, and the material feeding inlet configured to receive a material and transfer the material to the material passage structure; and
a heat source in communication with the reaction chamber, the heat source comprising one or more of: plasma, flame, combustion sources, resistive heaters, heated liquid baths, electromagnetic radiation, and/or induction heaters;
wherein the material passage structure is located within, surrounding, or adjacent to the heat source, such that the material passage structure is heated by the heat source and the material is converted to lithium iron phosphate (LFP) within the material passage structure.

12. The material processing apparatus of claim 11, wherein the heat source comprises a microwave plasma.

13. The material processing apparatus of claim 11, wherein the material passage structure comprises a helix geometry.

14. The material processing apparatus of claim 11, wherein the microwave plasma apparatus comprises a plurality of material passage structures, each material passage structure in communication with a material feeding inlet.

15. The material processing apparatus of claim 14, wherein each material passage structure comprises a helix.

16. The material processing apparatus of claim 15, wherein at least one material passage structure is nested within another material passage structure.

17. The material processing apparatus of claim 15, wherein at least one material passage structure is intertwined with another material passage structure.

18. The material processing apparatus of claim 14, wherein the plurality of material passage structures comprises 2, 3, 4, 5, 6, 7, 8, 9, or 10 material passage structures.

19. A method for producing lithium iron phosphate (LFP), the method comprising:
inputting a material to a material feeding inlet, the material feeding inlet in communication with a material passage structure, the material passage structure located within a reaction chamber;
transferring the material to the material passage structure; and
heating the material within the material passage structure by a heat source in communication with the reaction chamber, the heat source comprising one or more of: plasma, flame, combustion sources, resistive heaters, heated liquid baths, electromagnetic radiation, and/or induction heaters,
wherein the material passage structure is located within, surrounding, or adjacent to the heat source, such that the material passage structure is heated by the heat source and the material is converted to lithium iron phosphate (LFP) within the material passage structure.

20. The method of claim 19, wherein the heat source comprises a microwave plasma.
